(19) United States
(12) Patent Application Publication
(10) Pub. No.: US 2017/0253246 A1
(43) Pub. Date: Sep. 7, 2017

(54) POWER CONTROL APPARATUS FOR A LOAD IN A VEHICLE

(71) Applicant: Continental Automotive GmbH, Hannover (DE)

(72) Inventors: Rolf GRAF, Glashuetten (DE); Matthias BLUDAU, Stockstadt a. R. (DE)

(21) Appl. No.: 15/597,814

(22) Filed: May 17, 2017

Related U.S. Application Data
(63) Continuation of application No. PCT/EP2015/078404, filed on Dec. 2, 2015.

(30) Foreign Application Priority Data
Dec. 3, 2014 (DE) 102014224818.3
Jan. 27, 2015 (DE) 102015201315.4

(51) Int. Cl. B60W 30/188; B66C 13/24; B66C 13/40

(52) U.S. Cl. CPC B60W 30/1884; B66C 13/40; B60W 30/1882; B66C 13/24

(57) ABSTRACT

The electric energy provided to some loads in a vehicle is limited or controlled by a power controller that receives a signal specifying how much power should be provided to the load. When the link providing the power-specifying signal is lost, the controller adjusts the power to the load according to an internal temperature of the controller instead of simply providing full power to the load.

### FIELD OF THE INVENTION

The invention relates to a power control apparatus for providing an electrical output to a load. The power control apparatus may be for example an electrical or electronic function module for operating a regulator or an adjustment unit, particularly in an automobile. The invention further relates to a method for adjusting the electrical power delivered by a power control apparatus.

### BACKGROUND OF THE INVENTION

Modern automobiles are equipped with various electronic modules for operating an enormous range of regulators. One example of such an electronic module in an automobile is the actuator electronics for the fuel pump. In this case, the device in question is designed to regulate the speed of the pump in order to conserve energy by operation controlled in accordance with the current fuel requirement. These electronic modules are available in various designs. For example, they may be designed to actuate brush-type motors or brushless motors as well. The electronic power controllers have typical efficiencies of about 80 to 90% depending on the power class and other boundary conditions.

For reasons of cost, the layout of the electronics in modern automobiles can be designed such that a defined operation or operating range is possible just at the time under given environmental conditions (particularly temperatures) without causing local overload of the electronic modules. In this context, the operating mode of the electronic module, that is to say the regulator, may be continuous operation at maximum load and maximum temperature, but it may also be a profile of specific load states over a specific period of time.

With the desired minimal, cost-optimized design, operation at the upper ambient temperature results in the maximum temperatures being reached in the interior of the electronic modules, that is to say the regulators. When the electronic modules are configured and dimensioned appropriately, the permissible maximum temperature is also not exceeded.

In normal operation, communication between the electronic module and the engine controller takes place via a bus signal, for example, such as a CAN, or via a simple PWM interface. In normal operation, the engine controller typically receives feedback on the state of the regulator and is able to respond to fault or status messages and intervene appropriately, to actuate the regulator in a different operating range, for example.

Autonomous shutdown or even reduction of the system output by the electronic module, e.g., the fuel pump electronics, is generally not permissible; this should only be carried out according to a corresponding specification from the engine controller.

### SUMMARY OF THE INVENTION

The problem addressed by the invention may be considered to be the improvement of the functioning of an electronic module in an automobile, particularly if there is an interruption in the connection with a power control apparatus and the electronic module is working in autonomous mode.

This problem is solved by the objects of the independent claims. Additional variants are presented in the dependent claims and the following description. According to one aspect of the invention, a power control apparatus is presented that is configured to vary the electrical power delivered to a load. The power control apparatus has a control unit and a temperature acquisition unit. The control unit is configured to receive a power specification from a power specification unit and to detect an interruption in a connection between the power control apparatus and the power specification unit. The temperature acquisition unit is configured to detect a temperature of the power control apparatus. The control unit is further configured to change the electrical power delivered to the load depending on the temperature detected by the temperature acquisition unit in the event that the connection between the power control apparatus and the power specification unit is interrupted.

In particular, this makes it possible for the power control apparatus to operate autonomously if a connection between the power control apparatus and a power specification unit is interrupted. Such autonomous operation can also be described as emergency operation.

In an automobile, the functioning of individual modules normally needs to be coordinated. Thus for example, it may be necessary to control the delivery of power from a functional unit with the aid of a power control apparatus. On the other hand, it may also be necessary for the power control apparatus to receive a specification from a central power specification unit as to how the respective functional unit is to be actuated. The central power specification unit may be responsible for a coordination task. For example, it may be an engine controller and the power control apparatus may be configured to actuate a fuel pump (pump controller), so that the volumetric flow rate of the fuel output by the fuel pump is adapted to the current requirement of the engine. If the connection between the engine controller and the pump controller is interrupted, while the interruption exists the pump controller can no longer receive a specification regarding the quantity of fuel needed from a central location.

It may be a requirement in an automobile that the function of a fuel pump regulator for example can continue in emergency mode (“limp home mode”) even if communication is interrupted (e.g., due to a wiring fault), so that the automobile is not immobilized. It may also be a requirement that operation in emergency mode should not entail any limitation of driving performance and where applicable that the fault may not have to be corrected until the automobile is brought to the workshop for its next scheduled service. The consequence of these requirements is that “emergency mode” is a state that can persist for relatively long periods, and in which the fuel pump for example may be operated at high or even maximum performance. The quantity of fuel consumed by the combustion engine fluctuates substantially according to the driving state. As a consequence, it may happen that in idling or partial load situations, that is to say for most of the time the automobile is in operation, much too much fuel is delivered because the pump is being operated on the basis of a previously defined, high or maximum working point. This causes the pressure in the hydraulic system to build up until a mechanical pressure relief valve in the tank opens and the excess fuel is discharged back into the tank.

The fuel pump may be designed for example with a power input that is directly pressure-dependent at constant speed. As a consequence, operation in emergency mode at maximum pump speed and high pressure may result in the power consumption being higher than it is in normal mode for this speed. Losses in the electronic regulator also increase correspondingly. But particularly the regulator may not be configured for operation with this greater power loss at all ambient temperatures, with the result that at this operating point the power control apparatus may be damaged. Such a configuration of the power control apparatus is possible in principle, but it is not implemented for reasons of efficiency, since this operating point is in fact only rarely required.

Since changed boundary conditions exist in emergency mode and the ideal situation is maximum system availability for minimum cost, the power control apparatus described in this document provides that under certain conditions an autonomous gradual or incremental reduction of the set power is allowed, particularly taking into account the temperature of the power control apparatus.

The power control apparatus described herein enables maximum availability of the consumer without operating it under full load all the time. The temperature of the power control apparatus and/or of the load is taken into account for the level of power delivered, and the power is adapted even if the power specification is not provided because of an interrupted connection with the power specification unit.

According to one embodiment of the invention, the control unit is configured to reduce the electrical power that is delivered to the load when a predetermined temperature threshold value is reached.

This renders complicated control of the load in emergency mode unnecessary, since the power control apparatus ensures delivery of maximum power as a function of the temperature of the power control apparatus. Although the consumer load may not be taken into account, since the connection to the power control apparatus was interrupted, the maximum possible fuel quantity is still forwarded without overloading the pump controller and/or the power control apparatus.

The notion of reaching a temperature threshold value may be understood to mean that the temperature approaches a predetermined temperature value. In particular, approaching the predetermined temperature value through heating, that is to say from a low temperature towards the higher temperature threshold value. Once this temperature threshold value is reached, the electrical power delivered by the power control apparatus is reduced to give the power control apparatus the chance to cool down and minimize the risk of damage.

According to a further embodiment of the invention, the temperature threshold value is variable. This enables the operating behavior of the power control apparatus in emergency mode to be adapted to external boundary conditions.

According to a further embodiment of the invention, a thermal time constant of the power control apparatus is taken into account when calculating the amount of electrical power delivered.

The thermal time constant may be a parameter based on the thermal capacity and thermal flux between the power control apparatus and the environment. Together, these two variables may describe a cooling behavior of the power control apparatus.

In other words, this may make it possible to vary the electrical power delivered by the power control apparatus in such a way that a cooling behavior of the power control apparatus is taken into account. At the same time, particularly the ambient temperature of the power control apparatus may also be included.

According to a further embodiment of the invention, the control unit is configured to switch off the power control apparatus when a maximum permissible temperature threshold is reached.

The temperature threshold is particularly the temperature value at which the power control apparatus is at risk of being damaged. Accordingly, the power control apparatus is switched off autonomously only in emergency mode, that is to say when the connection to the power control apparatus has been interrupted.

According to a further aspect of the invention, a fluid pump assembly is described. The fluid pump assembly includes a fluid pump and a power control apparatus as described in the preceding and following text. The power control apparatus is coupled to the fluid pump in such a manner that it is able to deliver electrical power to the fluid pump. The fluid pump is configured to be able to vary a fluid pumping capacity as a function of the electrical power delivered to it.

According to a further embodiment of the invention, the fluid pump assembly is a fuel pump for an automobile.

In emergency mode as well, the fluid pump assembly forwards the maximum volumetric flow in the fuel line without overloading the power control apparatus, since the temperature of the power control apparatus is taken into account for the specification of the fuel pump speed. This can lengthen the service life of the power control apparatus and reduce the likelihood that faults and damage might occur.

The automobile is for example a motor vehicle such as a car, bus or truck, but it may also be a rail vehicle, a ship, an aircraft such as a helicopter or airplane, or for example a motorized bike. The vehicle is equipped with an internal combustion engine which is supplied with fuel by a fuel pump via a fuel line.

According to a further aspect of the invention, a vehicle with a fluid pump assembly is presented as described in the preceding and following text. The vehicle is further equipped with a fuel reservoir for holding a combustion fuel and an internal combustion engine whose operating behavior is controllable by an internal combustion engine controller. The fluid pump is arranged such that it is able to supply the combustion fuel from the fluid reservoir to the combustion engine. The combustion engine controller is designed to communicate a power specification for the fluid pump to the power control apparatus.

The internal combustion engine controller or engine controller is the power specification unit that actuates the power control apparatus in order to supply the fluid pump with electrical power and is thus able to influence the quantity of fuel transported.

According to an embodiment of the invention, the internal combustion engine controller is designed to regularly send a signal to the power control apparatus and to receive a response signal therefrom, so that the internal combustion engine controller can detect an interruption in the connection with the power control apparatus.

The regular signal to the power control apparatus may be a control signal, the absence of which indicates an interruption in the connection (regardless of whether the cause is mechanical or electrical). The power control apparatus may detect the interruption in the connection when it no longer receives the control signal, and the internal combustion engine controller detects the interruption in the connection when it no longer receives the response signal. The control signal may be a periodic signal, which is sent at predetermined, constant or variable time intervals. For example, such intervals may be a few seconds, one, two or more seconds, a few minutes, one, two or more minutes, and after these intervals have elapsed the control signal is sent again.

According to a further embodiment of the invention, the internal combustion engine controller is designed to calculate a power behavior of the power control apparatus if the connection to the power control apparatus has been interrupted.

The internal combustion engine controller is able to predict the behavior of the power control apparatus particularly taking into account the ambient temperature of the vehicle and the thermal behavior which is known to the internal combustion engine controller, e.g., by reading it out from a performance map which contains the ambient temperature of the vehicle and the electrical power delivered by the power control apparatus as well as other data. In this way, the internal combustion engine controller can control the engine without having a connection to the power control apparatus or being able to influence it, because the internal combustion engine controller is able to predetermine the behavior of the power control apparatus. For example, the internal combustion engine controller may also access the temperature of the power control apparatus for this purpose.

According to a further aspect of the invention, a method is described for adjusting the electrical power delivered by a power control apparatus. The method includes the following steps: Monitoring the status of a connection to a power specification unit; Operating the power control apparatus in emergency mode if the connection to the power control apparatus has been interrupted. In emergency mode, the following steps are performed:

determining a temperature of the power control apparatus;

adapting an electrical power delivered by the power control apparatus based on the temperature of the power control apparatus.

The method is executed in a similar manner to the operation of the power control apparatus, and the notes provided above in this regard therefore apply correspondingly for this method.

According to one embodiment of the invention, the electrical power delivered by the power control apparatus is reduced when the temperature of the power control apparatus reaches a predetermined threshold value.

The object described herein may be described in different terms as follows.

Since the boundary conditions in emergency mode are different and the ideal situation is to achieve maximum system availability for minimum cost, the power control apparatus described herein provides that under certain conditions an autonomous gradual or incremental reduction of the set power is allowed, particularly taking into account the temperature of the power control apparatus.

The first condition is the discontinuation of communication with the engine control device. Emergency mode is not usually invoked unless this situation has occurred. The second condition is contingent on reaching a high temperature inside the device, which temperature may still be below the absolute temperature limit for the device. If this situation occurs, the regulator can slowly lower the speed of the pump. The rate of deceleration can be chosen on the basis of the thermal time constant of the regulator. It may also be regulated to this temperature limit. Since the engine control unit (ECU) monitors the communication lines to such systems, it is “informed” about the “emergency mode” state. Since the ECU also “knows” the ambient temperature of the automobile, a corresponding behavior of the regulator can be predicted, also by suitable modeling taking into account the driving state. In this way, the autonomous intervention by the regulator then causes only minimal limitations to the behavior of the combustion engine. These features ensure that the full amount of fuel is available even in emergency mode at low temperatures. The quantity of pumped fuel only drops slowly in the relatively rare case of operation in significantly elevated ambient temperatures. In normal operation, the high ambient temperature does not impair operating performance under nominal pressure. Therefore, the loss of supply in emergency mode is typically only correspondingly proportional to the increased power consumption caused by increased operating pressure. Complete shutdown because certain limit temperatures have been exceeded may also be permissible in the emergency mode operating state to avoid catastrophic failure due to unexpected events. The described behavior is not limited only to fuel pumps, it can be applied to various electronically controlled regulators in an automobile. It saves costs by dispensing with a system designed to deliver maximum power under all operating conditions, including emergency mode.

The object can be summarized as follows in one embodiment:

Recognition of a communication failure as a condition for switching from normal to emergency mode, emergency mode as a condition for changed system behavior, emergency mode as a condition for thermal self-protection with autonomous change of pump speed, emergency operation also recognized by the engine controller through monitoring of the communication path, operation to thermal limit of the electronic regulator, adaptation of power losses in the electronics through down-regulation, regulation to an internal temperature threshold of the regulator, operation of the fuel pump at a working point corresponding to the ambient temperature, autonomous switch-off only in emergency mode.

In the following, exemplary embodiments of the invention will be described with reference to the figures.

### BRIEF DESCRIPTION OF THE FIGURES

FIG. 1 shows a schematic representation of a power control apparatus which is coupled to a power specification unit and a load.

FIG. 2 shows a schematic representation of a fluid pump assembly.

FIG. 3 shows a schematic representation of the steps of a method for adjusting the power that is delivered by a power control apparatus.

FIG. 4 shows a schematic representation of an automobile.

### DETAILED DESCRIPTION OF EMBODIMENTS

The representations in the figures are schematic and not shown to scale. Where the same reference signs are used, they refer to identical or similar elements.

### DETAILED DESCRIPTION

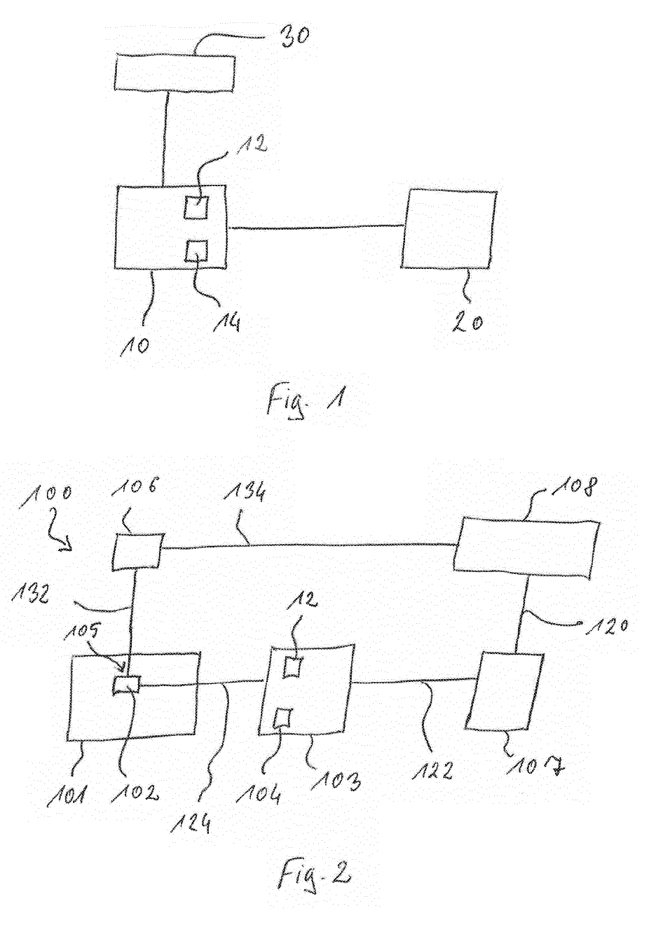

FIG. 1 shows a power control apparatus 10 which is coupled to a power specification unit 30 and a load 20. Power specification unit 30 is designed to transmit control signals to power control apparatus 10 for the purpose of specifying the functioning and the operating point, particularly the power delivered by power control apparatus 10 to load 20. Power control apparatus 10 is coupled to the load via a connection that is configured to transmit electrical energy for operation of the load.

Power control apparatus 10 includes a control unit 12 and a temperature acquisition unit 14, e.g., a temperature sensor.

Control unit 12 of power control apparatus 10 is designed to monitor the status of the connection with the power control apparatus, and in the event that said connection is interrupted to control the energy that is delivered to load 20 as described above, that is to say particularly taking into account the temperature of power control apparatus 10 detected by temperature acquisition unit 14.

FIG. 2 shows a fluid pump assembly 100 which includes a power control apparatus. In the embodiment shown in FIG. 2, the power control apparatus is a fuel pump control device or a fuel pump regulator 103. The temperature acquisition unit is designed as a temperature sensor 104. The load is a fluid pump in the form of a fuel pump 106, which is arranged in or on a fluid reservoir 101, e.g., a fuel tank in an automobile. The power specification unit is an engine controller 107.

Fluid pump 102 transports fuel from fluid reservoir 101 via a fuel line 132 to a second fuel pump 106, which increases the pressure on the fuel and supplies it to an engine 108 via fuel line 134.

Engine controller 107 controls the engine 108 via signal connection 120 and the fuel pump regulator 103 via signal connection 122 on the basis of the engine's operating point. Fuel pump regulator 103 transmits the required power to fuel pump 102 via electrical connection 124 in order to vary the quantity of fuel supplied.

FIG. 2 shows a fluid pump assembly 100 which particularly forms part of an automobile fluid supply system, for example part of a fuel supply system for diesel or gasoline for an internal combustion engine in the automobile. Fluid pump assembly 100 includes a tank 101 for storing the fuel. A fluid pump 102 is provided. In the exemplary embodiment, fluid pump 102 is a fuel pump. Fuel pump 102 is provided in order to transport the fuel from tank 101. In particular, fuel pump 102 is a “pre-feed” pump which is able to generate pressures of up to 8 bar at an outlet side 105 of fuel pump 102. Fuel pump 102 transports the fuel to another fuel pump 106, for example, which subjects the fuel to higher pressure, for example up to 500 bar in the case of gasoline and up to 3000 bar for diesel. Fuel pump 102 is electrically connected to a device 103. Device 103 is configured to control and/or regulate fuel pump 102. In particular, fuel pump 102 is a speed-controlled pump. Device 103 is for example part of a pump control device. Fuel pump 102 is thus regulated locally, thereby making it possible to relieve the engine controller of the pressure limitation function. Device 103 may be part of the engine controller or it may be a separate electronic regulator connected to engine controller 107 via a CAN bus for example, or it may be divided among several control devices. Device 103 is equipped with a temperature sensor 104 for determining ambient temperature and the temperature of device 103. Temperature sensor 104 may be provided on the printed circuit board of device 103, for example. In this way, the temperature may be evaluated easily and without additional costs due to a further sensor.

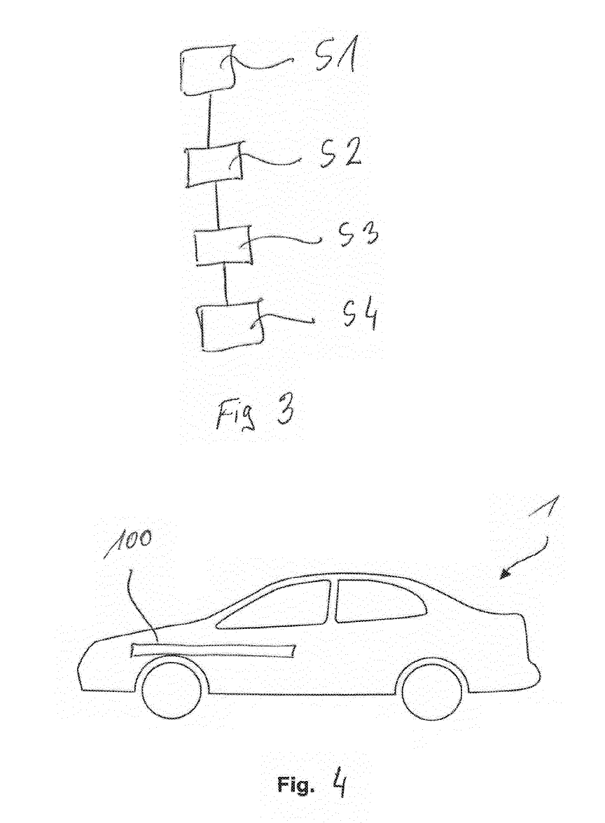

FIG. 3 shows a flowchart of the steps of a method for adjusting the electrical power delivered by a power control apparatus 10, 103. The method includes the following steps:

Monitoring S1 of the status of a connection to a power control apparatus 30, 107. Operating S2 the power control apparatus in an emergency mode if the connection to the power control apparatus has been interrupted. In emergency mode, determining S3 a temperature of the power control apparatus and adapting S4 an electrical power delivered by the power control apparatus based on the temperature of the power control apparatus.

FIG. 4 shows an automobile 1 equipped with a fluid pump assembly 100 as described in FIG. 2. The actual arrangement of the elements of fluid pump assembly 100 in the automobile may vary and is therefore only represented schematically in FIG. 4.

What is claimed is:

1. A power control apparatus configured to vary electrical power delivered to a load, the power control apparatus comprising:
a control unit, configured to:
receive a power specification from a power specification unit; and
detect an interruption of a connection between the power control apparatus a power specification unit;
a temperature acquisition unit configured to detect a temperature of the power control apparatus;
wherein, the control unit is configured to change the amount of electrical power delivered to the load responsive to a temperature detected by the temperature acquisition unit, when a connection between the power control apparatus and the power specification unit is interrupted.

2. The power control apparatus of claim 1, wherein the control unit is configured to reduce the electrical power delivered to the load when a predetermined temperature threshold value is detected.

3. The power control apparatus of claim 2, wherein the temperature threshold value is variable.

4. The power control apparatus of claim 1, wherein the amount of electrical power delivered is determined using a thermal time constant of the power control apparatus.

5. The power control apparatus of claim 1, wherein the control unit is configured to switch off the power control apparatus when a maximum temperature is reached detected.

6. A fluid pump assembly comprising:
a fluid pump, configured to vary a fluid pumping capacity as a function of electrical power provided to the fluid pump; and
a power control apparatus coupled to the fluid pump and configured to provide electrical power to the fluid pump.

7. The fluid pump assembly of claim 6, wherein the fluid pump assembly is a fuel pump assembly for a motor vehicle.

8. A motor vehicle comprising a fluid pump assembly as claimed in claim 6, the motor vehicle additionally comprising:
a fuel reservoir holding fuel for the motor vehicle;
an internal combustion engine, controlled by an internal combustion engine controller;
wherein the fluid pump is arranged such that it supplies fuel from the fuel reservoir to the combustion engine; and
wherein the combustion engine controller is configured to provide a fuel pump power specification to the power control apparatus.

9. The motor vehicle of claim 8, wherein the internal combustion engine controller sends a signal to the power control apparatus and receives a response signal therefrom, the internal combustion engine controller can being configured to detect when a response signal is not received.

10. The motor vehicle of claim 8, wherein the internal combustion engine controller is configured to calculate a power behavior of the power control apparatus when the connection to the power control apparatus is interrupted.

11. A method for adjusting the electrical power delivered by a power control apparatus to a load, the method comprising:
monitoring the status of a connection between the power control apparatus and the load;
operating the power control apparatus in an emergency mode when a connection between the power control apparatus and load is interrupted, the emergency mode comprising:
determining a temperature of the power control apparatus;
changing the amount of electrical power delivered by the power control apparatus to the load responsive to the temperature of the power control apparatus.

12. The method as claimed of claim 11, wherein the electrical power delivered by the power control apparatus to the load is reduced when the temperature of the power control apparatus has reached a predetermined limit value.
